(19) United States
(12) Patent Application Publication
(10) Pub. No.: US 2005/0011324 A1
(43) Pub. Date: Jan. 20, 2005

(54) Card cutting apparatus

(76) Inventors: Hitoshi Kawachi, Tokyo (JP); Keisuke Kawachi, Tokyo (JP)

Correspondence Address: Michael S. Leonard;Bell, Boyd & Lloyd LLC, P.O. Box 1135, Chicago, IL, 60690-1135, US

(21) Appl. No.: 10/889,427

(22) Filed: Jul. 12, 2004

(30) Foreign Application Priority Data
Jul. 16, 2003 (JP) 2003-275623

(51) Int. Cl. B26F 1/24; B26D 1/14

(52) U.S. Cl. 83/469; 83/471.1

(57) ABSTRACT

This invention provides a card cutting apparatus having a function capable of reliably peeling off trash sandwiched between two rotating disc blades of a slitter cutting section of the card cutting apparatus and capable of discharging the trash outside. A tip end of a guide member having a guide surface for discharging the trash is inserted close to a second rotation shaft or boss between thin blades, thereby peeling off the trash sandwiched between the thin blades and allowing the trash to fall along the guide surface of the guide member.

### BACKGROUND OF THE INVENTION

1. Field of the Invention

This invention relates to a card cutting apparatus which cuts a plain sheet or a card sheet on which a plurality of cards are printed into a desired card size, thereby forming individual cards. More particularly, the invention relates to a card cutting apparatus in which, in a slitter cutting section for cutting the card sheet along a transfer direction, trash sandwiched between a pair of second rotation blades disposed against both side surfaces of a first rotation blade can be removed.

2. Description of the Related Art

In a conventional card cutting apparatus, a plurality of cards are printed on one card sheet using a printer or a desktop printer, and a plurality of printed card sheets are stacked and accommodated in a paper feed cassette. The paper feed cassette accommodating the card sheets is set in the card cutting apparatus, the card sheets are supplied from the paper feed cassette into the card cutting apparatus one by one, the card sheet is cut in the lateral direction and vertical direction in a cutting section disposed in the card cutting apparatus, and a necessary number of cards which are cut into a desired size can be formed.

Plural upper rotation blades and lower rotation blades are disposed so as to sandwich a transfer path and rotate in opposite directions from each other with their axial directions perpendicular to a transfer direction. Plural pairs of upper and lower cutting portions are provided on the upper and lower rotation blades and the cutting in a longitudinal direction, that is, slitter cutting along the transfer direction in the card cutting apparatus is carried out between the pair of cutting portions. Further, it is widely employed to construct at least two pairs of the cutting portions in such a manner that the upper cutting portions are provided on both side surfaces of one upper rotation blade and the lower cutting portions are disposed with respect to the upper cutting portions on the both side surfaces of the upper rotation blade.

According to this configuration in which the cutting portions of the lower rotation blades are disposed against the cutting portions on both side surfaces of the upper rotation blade, trash is sandwiched and accumulated between the lower rotation blades adjacent to each other. And if the accumulated amount is increased, the cutting operation by the cutting section can not be carried out.

To solve this problem, there is a proposed slitter mechanism of a card cutting apparatus capable of allowing trash sandwiched between the adjacent rotation blades to fall from a gap (see Japanese Patent Laid-open Application No. 10-146796, for example).

The card cutting apparatus described in the Japanese Patent Laid-open Application No. 10-146796, as shown in FIG. 8, includes a slitter cutting section 40 which cuts, along a transfer direction, a card sheet (not shown) transferred in a vertical direction of the sheet. The slitter cutting section 40 includes a slitter which cuts the card sheet (not shown) in a longitudinal direction. The slitter includes an upper blade shaft 41 and a lower blade shaft 42 which rotate in opposite directions from each other. A plurality of disc-like upper blades 43 are provided on the upper blade shaft 41.

A plurality of disc-like lower blades 44 are provided on the lower blade shaft 42. The upper and lower blade shafts 41 and 42 work as rotation shafts of the disk-like upper and lower blades 43 and 44. The upper and lower blades 43 and 44 are disposed in such a manner that each of the upper and lower blade 43 and 44 is separated from other upper and lower blade 43 and 44 with predetermined intervals. The upper blades 43 and lower blades 44 correspond with each other and peripheral edges of the upper blades 43 and the lower blades 44 slid with each other. Among these upper and lower blades 43 and 44, two of the lower blades 44 are disposed adjacently so as to slide with both side surfaces of one of the disk-like upper blade 43. A trash-peeling piece 45 having a pointed tip end is disposed between the adjacent two disc-like lower blades 44. As shown in FIG. 9, trash 46 sandwiched between the adjacent two disc-like lower blades 44 is striated by the pointed tip end of the trash-peeling piece 45 to reduce its width and bent to form an angle portion 47 so as to fall from between the two disc-like lower blades 44.

However, in order to striate the inner side of the curved trash 46 sandwiched between the two disc-like lower blades 44 over its entire length by the pointed tip end of the trash-peeling piece 45, and in order to bend the trash 46 to form the angle portion 47 so as to reduce the width thereof, it is necessary to assemble the apparatus so as to precisely position the trash-peeling piece 45.

Even if the apparatus is assembled precisely, there is no guarantee that the trash 46 is always sandwiched at the same position between the lower blades 44. When the trash 46 is sandwiched at the position slightly deeper from the outer periphery of the lower blades 44 than the expected position in design, the trash 46 enters farther inside than the pointed tip end of the trash-peeling piece 45. Thus the trash-peeling piece 45 can not make the trash 46 fall from between the lower blades 44 and its original object can not be achieved.

### SUMMARY OF THE INVENTION

It is an object of the invention to provide a card cutting apparatus having a function capable of reliably peeling off trash sandwiched between two rotating disc blades of a slitter cutting section of the card cutting apparatus and capable of discharging the trash outside.

The above object can be achieved by this invention.

That is, the invention provides a card cutting apparatus comprising: a pair of rotation shafts each of which is disposed on an opposite side of a transfer path of a sheet to each other, rotates in an opposite direction from each other and has an axial direction perpendicular to a transfer direction of the sheet; a plurality of first rotation blades disposed at predetermined distances from one another in the axial direction of one of the rotation shafts; and a plurality of second rotation blades disposed in the axial direction of the other rotation shaft in such a manner that that peripheral edges of the second rotation blades and the first rational blades slide with each other to constitute a slitter cutting section, wherein a pair of second rotation blades are disposed against both side surfaces of at least one of the first rotation blades, being characterized by a guide member inserted between the pair of second rotation blades for peeling off the trash sandwiched between the pair of second rotation blades and discharging the trash outside.

The invention is characterized in that the guide member has an obliquely downsweeping guide surface.

The invention is characterized in that the guide member is constructed as a rod body and the rod body extends so as to bypass a rotation shaft of the pair of second rotation blades, or the guide member is constructed as a plate body formed with a through hole through which the rotation shaft between the pair of second rotation blades passes.

The card cutting apparatus of the invention has a configuration for peeling off and discharging the trash sandwiched between the pair of second rotation blades disposed against both side surfaces of at least one of the first rotation blade by means of the guide member inserted between the pair of second rotation blades. Thus, it is possible to reliably peel off and discharge the trash by the guide member from the second rotation blades without pushing the trash sandwiched between the pair of second rotation blades into a deep portion between the second rotation blades.

With this configuration, the number of maintenance operations in the cutting section of the card cutting apparatus can be minimized, and the card can be cut always in a stable state.

The guide member is provided with the obliquely downsweeping guide surface. Thus, it is possible to smoothly and reliably peel off and discharge the trash sandwiched between the pair of second rotation blades along the obliquely downsweeping guide surface from the second rotation blades.

Any member can be used as the guide member if it can be inserted between the pair of second rotation blades. If the rod body, or the plate body which is inserted between the pair of second rotation blades and which has a through hole through which the rotation shaft of the second rotation blade passes is used, it is possible to easily discharge the trash sandwiched between the pair of second rotation blades with a simple structure.

At this time, it is preferable that a thickness of the rod body or the plate body is narrower than a distance between the pair of second rotation blades, and the rod body or the plate body does not abut against the pair of second rotation blades. The rod body or the plate body is disposed in the vicinity of a boss fixing at least a pair of second rotation blade to the rotation shaft or in the vicinity of the rotation shaft of the second rotation blade. With this configuration, the trash sandwiched between the pair of second rotation blades is not accumulated between the pair of second rotation blades and the trash can be reliably discharged outside.

When the rod body is used as the guide member, the rod body can be extended so as to bypass the rotation shaft of the pair of second rotation blades. At this time, both ends of the rod body can be fixed to a fixing member of the card cutting apparatus separated from the second rotation blades. With this configuration, it is possible to securely prevent the rod body from abutting against the side surfaces or the like of the pair of second rotation blades.

When the rod body or plate body is used as the guide member, it is necessary to dispose the same such that it does not interfere with the pair of second rotation blades and the first rotation blade and such that the transfer of the card sheet transferred into the cutting section is not hindered.

The rod body may be cylindrical in shape or it may have any cross sectional shape such as a rectangular as long as the rod body has a shape capable of peeling off the trash sandwiched between the pair of second rotation blades and discharging the trash outside.

It is preferable that a thick rotation blade is used as the first rotation blade and a thin rotation blade is used as the second rotation blade. However, the invention is not limited to the configuration with the thick or thin rotation blade and any disc-like rotation blade can be used.

### BRIEF DESCRIPTION OF THE DRAWINGS

FIG. 1 is a sectional view showing one example of a card cutting apparatus according to the invention (first embodiment);

FIG. 2 is a partially enlarged view of a slit cutting section (first embodiment);

FIG. 3 is a sectional side view taken along a line III-III in FIG. 2 (first embodiment);

FIG. 4 is a sectional side view of the slit cutting section (second embodiment);

FIG. 5 is a sectional side view of the slit cutting section (third embodiment);

FIG. 6 shows a print state of a card sheet (first embodiment);

FIG. 7 shows another print state of a card sheet (first embodiment);

FIG. 8 is a front view of a slitter section (conventional example); and

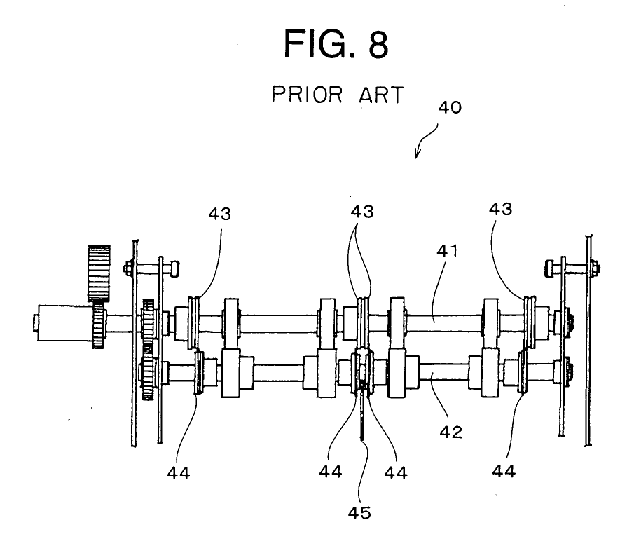

FIG. 9 is a partial perspective view of the slitter section (conventional example).

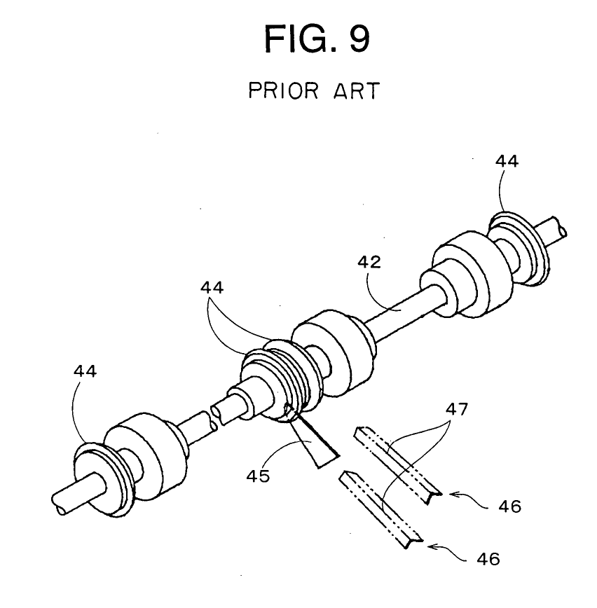

### DESCRIPTION OF THE PREFERRED EMBODIMENTS

According to the invention, a guide member for peeling off trash sandwiched between a pair of second rotation blades and for discharging the trash outside is inserted between the pair of second rotation blades. With this configuration, the trash sandwiched between the pair of second rotation blades of the card cutting apparatus is reliably peeled off and discharged outside.

The guide member of the invention includes a guide surface which downsweeps obliquely. The guide member may be formed into a rod shape. When this shape is employed, the guide member may be disposed so as to extend while bypassing the periphery of a rotation shaft of the pair of second rotation blades. Alternatively, the guide member may be formed into a plate shape formed with a through hole through which the rotation shaft between the pair of second rotation blades passes. Preferred embodiments of the invention will be explained concretely below based on the accompanying drawings.

[First Embodiment]

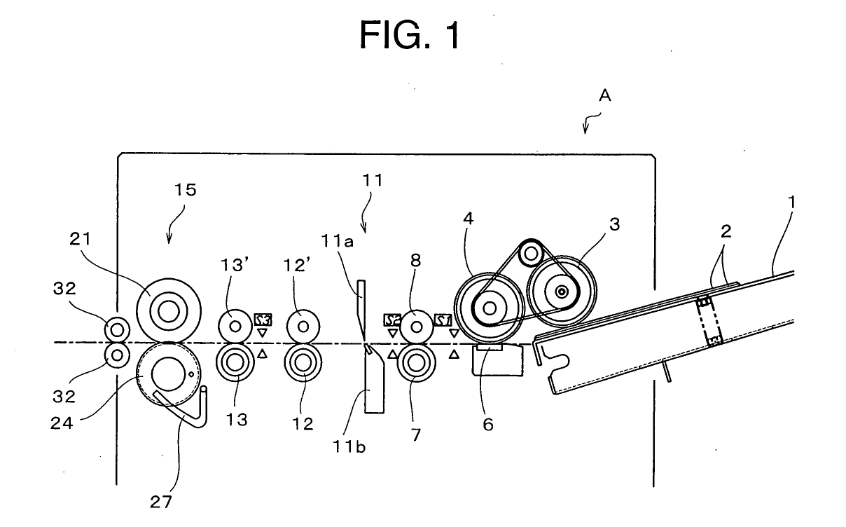

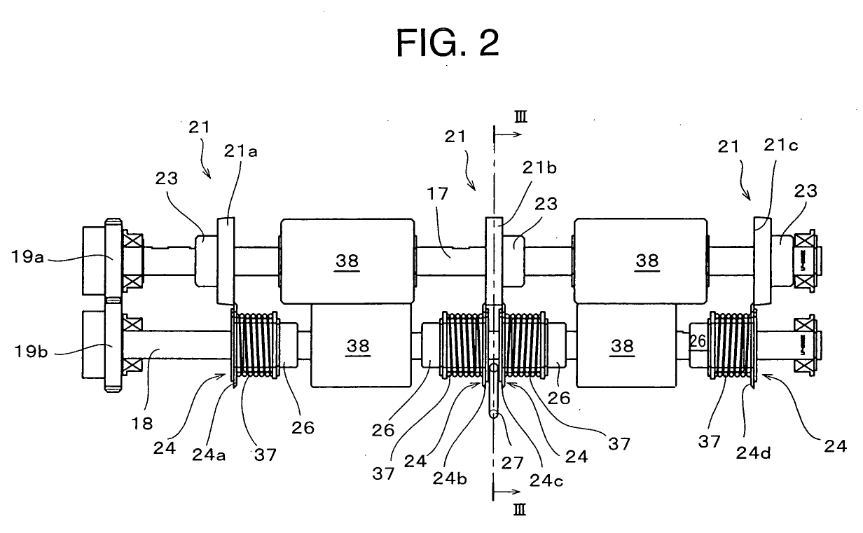

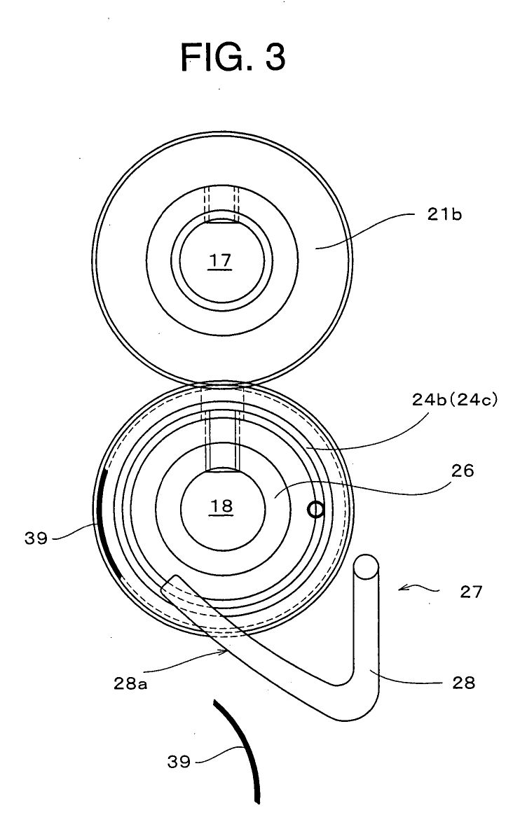

FIG. 1 is a schematic sectional view showing the entire card cutting apparatus according to the invention, and FIG. 2 is a front view of a slitter cutting section in FIG. 1. FIG. 3 is a sectional side view of a slitter cutting section taken along a line III-III in FIG. 2. An outline of the card cutting apparatus of the invention will be explained using FIG. 1.

A plurality of card sheets 2 is stacked on a paper feed stage 1 and the card sheet 1 is taken out one by one by a pick-up roller 3 disposed downstream of the paper feed stage 1 and transferred to a paper feed roller 4. The paper feed roller 4 is disposed in a state in which it is in contact with a plural-paper-feeding preventing pad 6 with pressure. If a plurality of card sheets 2 are erroneously transferred to the paper feed roller 4 at the same time, friction force of the paper feed roller 4 and the plural-paper-feeding preventing pad 6 can prevent it. The paper feed roller 4 securely sends only one card sheet 2 at a time to a first transfer roller 7 and a first transfer pressurizing roller 8 disposed at the downstream side.

A first detecting sensor S1 is disposed between the paper feed roller 4 and the first transfer roller 7. The first detecting sensor S1 can detect whether or not side end portions of the card sheet 2 transferred by the paper feed roller 4 are deviated from a transfer direction by a predetermined amount or more.

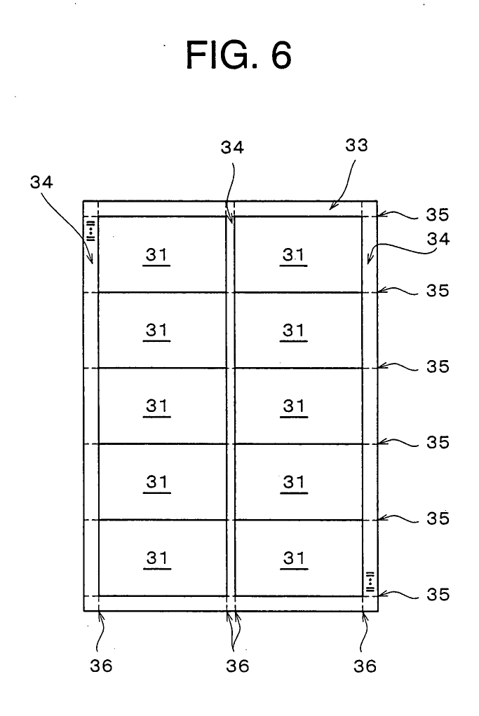

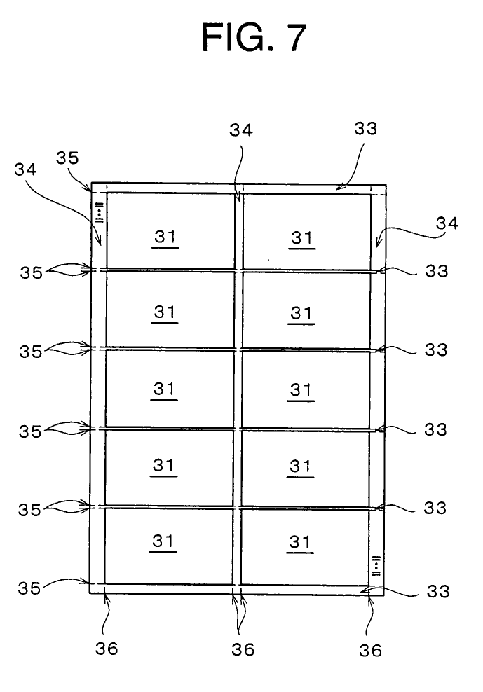

As shown in FIGS. 6 and 7, a plurality of portions which are to be formed as cards are printed on the card sheet 2 and the card sheet 2 is transferred by the card cutting apparatus. When a special card sheet is used, a symbol such as “∥..∥” is marked on a portion near a corner of the card sheet 2 where no card portion is formed. With this configuration, it is possible to judge whether or not the sheet is a special sheet by detecting this symbol.

Although the paper feed stage 1 is used in this embodiment, a card cutting apparatus A of this invention can use a paper feed cassette in which a plurality of card sheets are stacked instead of the paper feed stage 1.

A second sensor S2 is disposed downstream from the first transfer roller 7 and the first transfer pressurizing roller 8. If the second sensor S2 detects a tip end of the transferred card sheet 2, the transfer operation by the first transfer roller 7 and the first transfer pressurizing roller 8 is controlled so that a predetermined length of the card sheets 2 are intermittently transferred into a lateral cutting section 11.

A pair of upper and lower blades is disposed in the lateral cutting section 11. The card sheet 2 which is intermittently transferred by the first transfer roller 7 is cut in a lateral direction perpendicular to the transfer direction by the pair of upper and lower cutting blades 11a and 11b in synchronization with the intermittent drive control of the first transfer roller 7. One blade of the paired upper and lower cutting blades 11a and 11b vertically moves with respect to the other blade, and the other blade is fixed.

FIGS. 6 and 7 show an arrangement of card portions 31 which are printed on the card sheet 2 and to be cut in plural cards. The card sheet 2 on which the plurality of card portions 31 are printed is intermittently transferred by the first transfer roller 7 and positioned such that a lateral cut line 35 shown in FIGS. 6 and 7 comes to a cutting position of the pair of upper and lower cutting blades 11a and 11b disposed in the lateral cutting section 11.

After the card sheet 2 is set on the cutting position, the card sheet 2 is cut along the lateral cut line 35 shown in FIGS. 6 and 7 by the pair of upper and lower cutting blades 11a and 11b. After the cutting operation, the card sheet 2 is intermittently transferred and positioned by the first transfer roller 7 such that the next lateral cut line 35 comes to the cutting position of the pair of upper and lower cutting blades, and the card sheet 2 is sequentially cut by the pair of upper and lower cutting blades 11a and 11b.

That is, a margin close to the tip end of the card sheet 2 which is first intermittently transferred into the lateral cutting section 11 by the first transfer roller 7 is cut off along the lateral cut line 35, and the margin falls into a margin box (not shown) disposed below the lateral cutting section 11 and is accommodated therein. The card sheet 2 whose margin 33 was cut off is intermittently transferred by the first transfer roller 7, sandwiched between a second transfer pressurizing roller 12′ and a second transfer roller 12, and kept being transferred. If the lateral cut line 35 is positioned on the cutting position of the pair of upper and lower cutting blades 1a and 11b, the transfer operation of the first transfer roller 7 and the second transfer roller 12 is stopped and the card sheet 2 is cut along the lateral cut line 35.

Regardless of whether the card sheet 2 does not have the margin 33 in the longitudinal direction between the card and the next card, i.e., the card sheet 2 does not have a margin formed in the transfer direction of the card sheet 2 as shown in FIG. 6, or the margin 33 in the longitudinal direction exists between the card and the next card as shown in FIG. 7, the card portion which was cut and separated is sent to a third transfer roller 13 by the second transfer roller 12.

The card sheet 2 whose card portion was cut and separated is intermittently transferred by the first transfer roller 7 such that the next lateral cut line 35 comes to the cutting position of the pair of upper and lower cutting blades 11a and 11b and is positioned. When the margin 33 in the longitudinal direction exists between the card and the next card as shown in FIG. 7, the longitudinal margin 33 is cut at the next cutting operation, and the cut longitudinal margin 33 falls into a margin box (not shown) and is accommodated therein.

A third sensor S3 is disposed between the second transfer roller 12 and the third transfer roller 13. The third sensor S3 detects a card tip end which was transferred by the second transfer roller 12 and cut in the lateral direction. By the detection of the card tip end by the third sensor S3, the transfer operation by the third transfer roller 13 into the slitter cutting section 15 is controlled.

A plurality of the first rotation blades 21 and second rotation blades 24 are disposed in the slitter cutting section 15 such that the first rotation blades 21 and the second rotation blades 24 rotate in opposite directions from each other interposing a transfer path as shown in FIG. 2. Each of the first rotation blades 21 is mounted on a first rotation shaft 17 and disposed at a position corresponding to the vertical cut line 36 to be cut. Each of the second rotation blade 24 is mounted on a second rotation shaft 18, and biased by a spring 37 such that peripheral edges of the second rotation blade 24 and the first rotation blade 21 slide with each other for cutting the card sheet 2 along the vertical cut line 36 between the first rotation blade 21 and the second rotation blade 24.

The first rotation shaft 17 and the second rotation shaft 18 are rotatably supported by bearings. Gears 19a and 19b mounted on ends of the shafts 17 and 18 mesh with each other so that they are rotated in the opposite directions from each other by rotation force from a rotation-driving source (not shown).

The first rotation blade 21 is mounted on the first rotation shaft 17 so as to rotate in unison with the first rotation shaft 17 through a boss 23. The second rotation blade 24 is mounted on the second rotation shaft 18 so as to move in an axial direction of the second rotation shaft 18 and fixed to rotate in unison with the second rotation shaft 18 through the boss 26. The first rotation blades 21 are formed as thick blades 21a to 21c, and the second rotation blades 24 are formed as thin blades 24a to 24d. The thick blades 21a to 21c of the first rotation blades 21 can support the vicinity of the card portion to be slit. The thin blades 24a to 24d of the second rotation blades 24 can precisely cut the end supported by the thick blades.

A pair of wide rollers 38 are disposed between the first rotation blades 21 and between the second rotation blades 24. With this configuration, it is possible to reliably support the card portion to be slit, and to prevent a skew or the like.

The left and right margins 34 shown in FIGS. 6 and 7 are cut by the thick blade 21a of the first rotation blade 21 and the thin blade 24a of the second rotation blade 24, and by the thick blade 21c of the first rotation blade 21 and the thin blade 24d of the second rotation blade 24. The margins 34 between the cards are cut by the thick blade 21b of the first rotation blade 21 and the thin blades 24b and 24c of the second rotation blades 24. The card portion 31 cut by the slitter cutting section 15 is discharged outside by a discharge roller 32 and accommodated in a product receiver (not shown).

Left and right cut margins 34 fall freely and are accommodated in the margin box, but a margin 34 between cards may be sandwiched between the thin blade 24b and the thin blade 24c as trash 39 in some cases. The trash 39 sandwiched between the thin blade 24b and the thin blade 24c is peeled off from between the thin blades 24b and 24c by means of a guide member 27 including guide surfaces 28a 29a, 30a for discharging the trash inserted between the thin blades 24b and 24c, thereby allowing the trash to fall into the margin box (not shown) disposed below the slitter cutting section 15.

The guide member 27 is constructed as a rod body 28. One end of the guide member 27 is fixed to a fixing section (not shown) of a card cutting apparatus body A, and a tip end of the other end of the guide member 27 is inserted between the thin blades 24b and 24c so as to form the obliquely downsweeping guide surface 28a as shown in FIG. 3. The tip end of the rod body 28 inserted between the thin blades 24b and 24c extends close to the second rotation shaft 18 or the boss 26 between the thin blades 24b and 24c, thereby preventing the trash 39 from being pushed toward the second rotation shaft 18 and achieving reliable discharge of the trash 39 along the guide surface 28a.

A cross section of the rod body 28 may be circular or rectangular in shape. As a material of the rod body 28, it is possible to use metal, synthetic resin, wood and the like if the material has enough strength to guide and discharge the trash 39 and not to come into contact with the thin blades 24b and 24c.

[Second Embodiment]

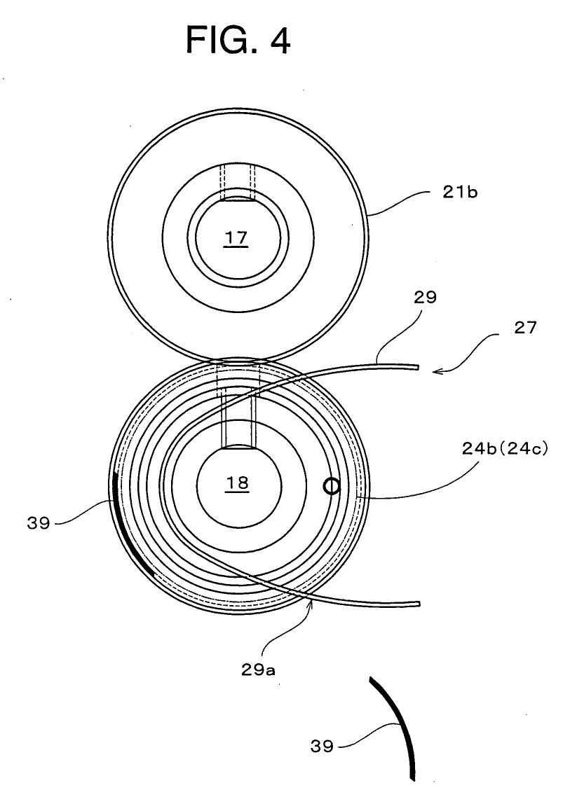

FIG. 4 shows another embodiment of the guide member 27. The second embodiment is different from the first embodiment only in the configuration of the guide member 27, and other configuration is the same as that of the first embodiment. Therefore, the same reference symbols are used for the same members and explanation of the same members will be omitted.

As shown in FIG. 4, the guide member 27 is constructed as a substantially C-shaped rod body 29, and the guide member 27 extends such that the substantially C-shaped bent portion bypasses the second rotation shaft 18. Both ends of the substantially C-shaped rod body 29 are fixed to a fixing section (not shown) of the card cutting apparatus body A. The substantially C-shaped bent portion or the like does not project from the outermost peripheries of the thin blades 24b and 24c of the second rotation blades 24, and is located at a position where the bent portion or the like does not interfere with the card which is being transferred.

With this configuration, it is possible to reliably discharge the trash 39 outside along the guide surface 29a. Like the rod body 28 of the first embodiment, a cross section thereof may be circular or rectangular in shape, and it is possible to use metal, synthetic resin, wood and the like as the material of the rod body 29 if the material has enough strength to guide and discharge the trash 39 and not to come into contact with the thin blades 24b and 24c.

[Third Embodiment]

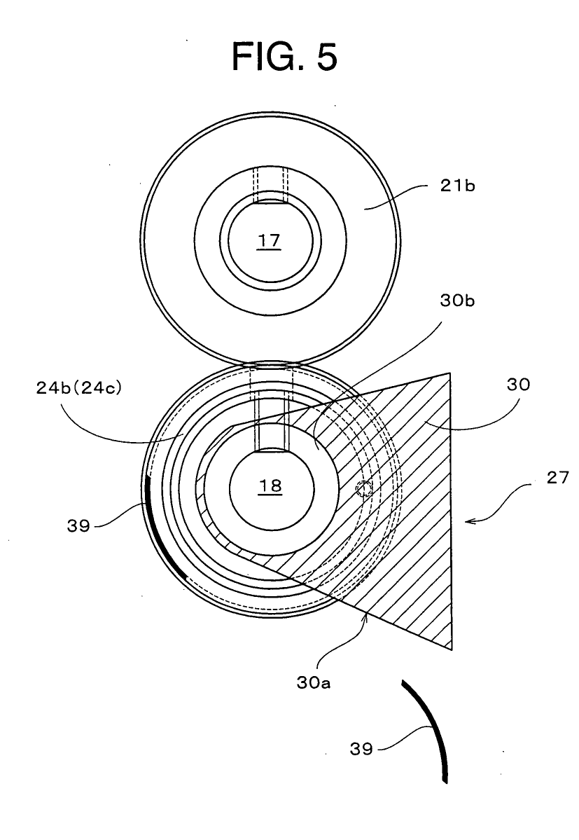

FIG. 5 shows another embodiment of the guide member 27. The third embodiment is different from the first embodiment only in the configuration of the guide member 27, and other configuration is the same as that of the first embodiment. Therefore, the same reference symbols are used for the same members and explanation of the same members will be omitted.

As shown in FIG. 5, the guide member 27 is constructed as a plate body 30, and formed with a through hole 30b through which the second rotation shaft 18 or boss 26 between the thin blades 24b and 24c is inserted. An end surface of the plate body 30 is fixed to a fixing section (not shown) of a body of the card cutting apparatus A. The plate body 30 does not come into contact with the trash 39 except its guide surface 30a which peels off the trash 39 from between the thin blades 24b and 24c. The plate body 30 has such a shape that it does not interfere with the card which is being transferred. A peripheral edge of the plate body 30 may be flat surface or curved surface in shape, and it is possible to use metal, synthetic resin, wood and the like as the material of the plate body 30 if the material has enough strength to guide and discharge the trash 39 and not to come into contact with the thin blades 24b and 24c.

According to the card cutting apparatus of this invention, it is possible to reliably discharge the trash sandwiched between the pair of rotation blades when slitting the sheet. The card cutting apparatus can be used when there is a danger that the trash is sandwiched between the pair of rotation blades when slitting the sheet.

1. A card cutting apparatus comprising:
a pair of rotation shafts each of which is disposed on an opposite side of a transfer path of a sheet to each other, rotates in an opposite direction from each other and has an axial direction perpendicular to a transfer direction of the sheet;
a plurality of first rotation blades disposed at predetermined distances from one another in the axial direction of one of the rotation shafts; and
a plurality of second rotation blades disposed in the axial direction of other one of the rotation shafts in such a manner that peripheral edges of the first rotation blades and the second rotation blades slide with each other to constitute a slitter cutting section, wherein a pair of second rotation blades are disposed against both side surfaces of at least one of the first rotation blades, and a guide member is inserted between the pair of second rotation blades for peeling off trash sandwiched between the pair of second rotation blades and discharging the trash outside.

2. The card cutting apparatus according to claim 1, wherein the guide member includes an obliquely downsweeping guide surface.

3. The card cutting apparatus according to claim 1 or 2, wherein the guide member is constructed as a rod body.

4. The card cutting apparatus according to claim 3, wherein the rod body extends so as to bypass a rotation shaft of a pair of second rotation blades.

5. The card cutting apparatus according to claim 1 or 2, wherein the guide member is constructed as a plate body formed with a through hole through which the rotation shaft between the pair of second rotation blades passes.
